(19) United States
(12) Patent Application Publication
(10) Pub. No.: US 2014/0040000 A1
(43) Pub. Date: Feb. 6, 2014

(54) SERVER APPARATUS AND RECORDING MEDIUM

(71) Applicant: DeNa Co., Ltd., Tokyo (JP)

(72) Inventor: Ayumi TAKANO, Tokyo (JP)

(73) Assignee: DeNa Co., Ltd.

(21) Appl. No.: 13/909,224

(22) Filed: Jun. 4, 2013

(30) Foreign Application Priority Data
Jul. 31, 2012 (JP) 2012-169734

(51) Int. Cl. G06Q 30/02

(52) U.S. Cl. CPC G06Q 30/0224
USPC 705/14.25

(57) ABSTRACT

A server apparatus includes an entry detection unit that detects an entry by a user from a terminal device; an entry condition determining unit that determines whether the entry satisfies a predetermined entry condition; an entry history storing unit that stores at least a history of the entry that satisfies the predetermined entry condition; a predetermined entry data providing unit that stores data indicating that the entry satisfies the predetermined entry condition as the history in the entry history storing unit; an editing unit that accepts an edition to the history under a condition that a predetermined counter value by the user is accepted; a prize condition determining unit that determines, in a current condition, whether the history satisfies the prize condition; and a prize providing unit that provides a prize to the user when, in the current condition, the history satisfies the prize condition.

### BACKGROUND OF THE INVENTION

1. Field of the Invention

The present invention relates to a server apparatus and a recording medium.

2. Description of the Related Art

Conventionally, a so-called stamp rally is known in which a prize is given to a user who collects stamps for promotion, events or the like for a shop.

Patent Document 1 discloses a delivery of an electronic coupon using electronic stamps provided to a user (customer) when the user visits a shop. A single electronic stamp is provided to the user each day the user visited the shop. Then, the user is provided with an electronic coupon with predetermined service content in accordance with the amount of the collected electronic stamps.

In a game provided via a network, a stamp rally is also performed in order to give an incentive for a user (player) to enter the game.

In such a stamp rally, a stamp is provided to a user each day the user enters the game. Then, a prize such as a rare card, a rare item or the like is provided to the user when the user continuously enters the game for a predetermined number of days.

However, when the predetermined number of days is long (for example, a week), it may be difficult for a user to continuously enter the game for the predetermined number of days without lacking a day.

Thus, if the user cannot enter the game for only one day and the user misses the stamp, the user may be discouraged to enter the game again from there on.

### Patent Document

[Patent Document 1] Japanese Laid-open Patent Publication No. 2010-176282

### SUMMARY OF THE INVENTION

The present invention is made in light of the above problems, and provides a service, in which a prize is given to a user by collecting stamps or the like, capable of increasing options that the user can select.

According to an embodiment, there is provided a server apparatus including: an entry detection unit that detects an entry by a user from a terminal device; an entry condition determining unit that determines whether the entry satisfies a predetermined entry condition when the entry is detected by the entry detection unit; an entry history storing unit that stores at least a history of the entry that satisfies the predetermined entry condition; a predetermined entry data providing unit that stores data indicating that the entry satisfies the predetermined entry condition as the history in the entry history storing unit when the entry condition determining unit determines that the entry satisfies the predetermined entry condition; an editing unit that accepts an edition to the history under a condition that a predetermined counter value by the user is accepted; a prize condition determining unit that determines, in a current condition, whether the history satisfies the prize condition; and a prize providing unit that provides a prize to the user when, in the current condition, the history satisfies the prize condition.

According to another embodiment, there is provided a server apparatus including: an entry detection unit that detects an entry by a user from a terminal device; an entry condition determining unit that determines whether the entry satisfies a predetermined entry condition when the entry is detected by the entry detection unit; an entry history storing unit that stores at least a history of the entry that satisfies the predetermined entry condition; a predetermined entry data providing unit that stores data indicating that the entry satisfies the predetermined entry condition as the history in the entry history storing unit when the entry condition determining unit determines that the entry satisfies the predetermined entry condition; an editing unit that accepts an edition to a prize condition under a condition that a predetermined counter value by the user is accepted; a prize condition determining unit that determines, in a current condition, whether the history satisfies the prize condition; and a prize providing unit that provides a prize to the user when, in the current condition, the history satisfies the prize condition.

According to another embodiment, there is provided a non-transitory computer-readable recording medium having recorded thereon a program for a server apparatus that causes a computer to execute functions including: an entry detection function that detects an entry by a user from a terminal device; an entry condition determining function that determines whether the entry satisfies a predetermined entry condition when the entry is detected by the entry detection function; an entry history storing function that stores at least a history of the entry that satisfies the predetermined entry condition; a predetermined entry data providing function that stores data indicating that the entry satisfies the predetermined entry condition as the history in the entry history storing function when the entry condition determining function determines that the entry satisfies the predetermined entry condition; an editing function that accepts an edition to the history under a condition that a predetermined counter value by the user is accepted; a prize condition determining function that determines, in a current condition, whether the history satisfies the prize condition; and a prize providing function that provides a prize to the user when, in the current condition, the history satisfies the prize condition.

According to another embodiment, there is provided a non-transitory computer-readable recording medium having recorded thereon a program for a server apparatus that causes a computer to execute functions including: an entry detection function that detects an entry by a user from a terminal device; an entry condition determining function that determines whether the entry satisfies a predetermined entry condition when the entry is detected by the entry detection function; an entry history storing function that stores at least a history of the entry that satisfies the predetermined entry condition; a predetermined entry data providing function that stores data indicating that the entry satisfies the predetermined entry condition as the history in the entry history storing function when the entry condition determining function determines that the entry satisfies the predetermined entry condition; an editing function that accepts an edition to a prize condition under a condition that a predetermined counter value by the user is accepted; a prize condition determining function that determines, in a current condition, whether the history satisfies the prize condition; and a prize providing function that provides a prize to the user when, in the current condition, the history satisfies the prize condition.

Note that also arbitrary combinations of the above-described elements, and any changes of expressions in the present invention, made among methods, devices, systems, recording media, computer programs and so forth, are valid as embodiments of the present invention.

### BRIEF DESCRIPTION OF THE DRAWINGS

Other objects, features and advantages of the present invention will become more apparent from the following detailed description when read in conjunction with the accompanying drawings.

FIG. 1 is a block diagram illustrating a structure of an example of a system of an embodiment;

FIG. 2 is a block diagram illustrating an example of a hardware structure of a terminal device;

FIG. 3 is a block diagram illustrating an example of a hardware structure of a game processing server apparatus;

FIG. 4 is a block diagram illustrating an example of a functional structure of the terminal device and the game processing server apparatus;

FIG. 5 is a view illustrating an example of a data structure of a condition storing unit;

FIG. 6 is a view illustrating an example of a data structure of a player information database;

FIG. 7A and FIG. 7B are views illustrating an example of a stamp history;

FIG. 8 is a view illustrating an example of a condition after editing;

FIG. 9 is a view illustrating an example of a data structure of an item information database;

FIG. 10 is a sequence diagram illustrating an example of an operation of the embodiment;

FIG. 11 is a view illustrating an example of a screen of a terminal device;

FIG. 12 is a view illustrating an example of a screen of a terminal device;

FIG. 13 is a view illustrating an example of a screen of a terminal device;

FIG. 14 is a view illustrating an example of a screen of a terminal device; and

FIG. 15 is a sequence diagram illustrating another example of an operation of the embodiment.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

Although a game using a network is exemplified in the following embodiment, the embodiment is adaptable for an arbitrarily service not limited to a game.

### (Structure)

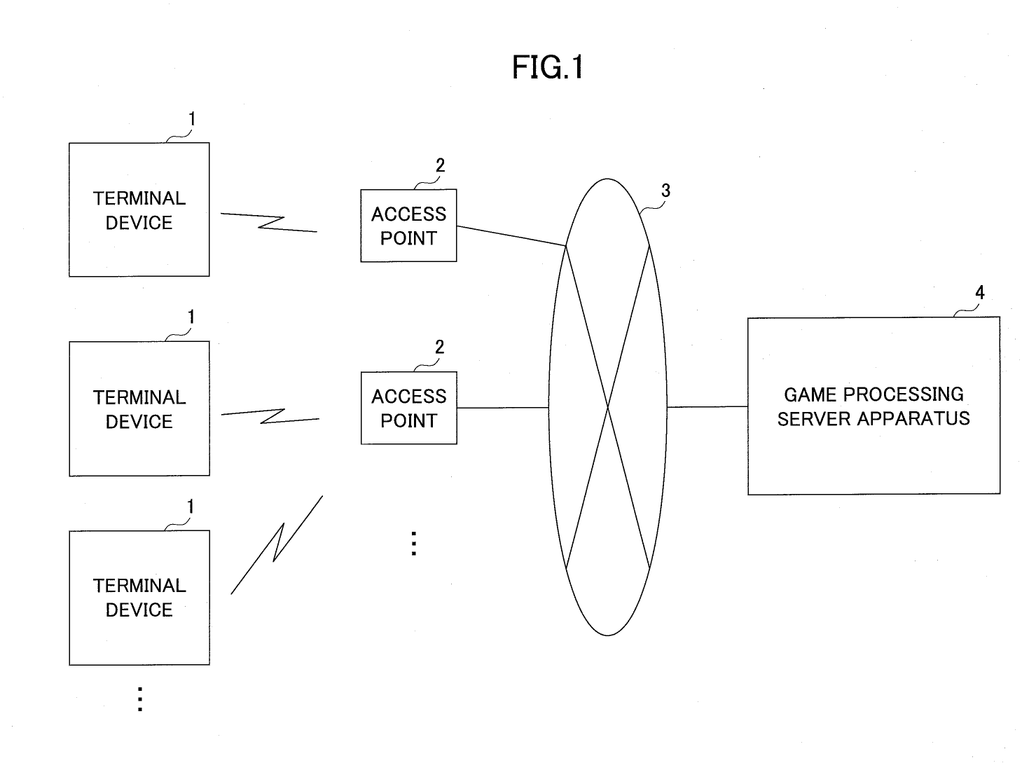

FIG. 1 is a block diagram illustrating a structure of an example of a system of an embodiment.

The system shown in FIG. 1 includes a plurality of terminal devices (player terminals) 1 which belong to players, respectively, access points 2 such as a mobile base station, a Wi-Fi station or the like, a network 3 such as the INTERNET or the like, and a game processing server apparatus 4 (an example of a processing server apparatus). The game processing server apparatus 4 controls (manages) processing of a game in which a plurality of players play a game via the network 3. The terminal device 1 may be a smart phone, a mobile phone, or the like.

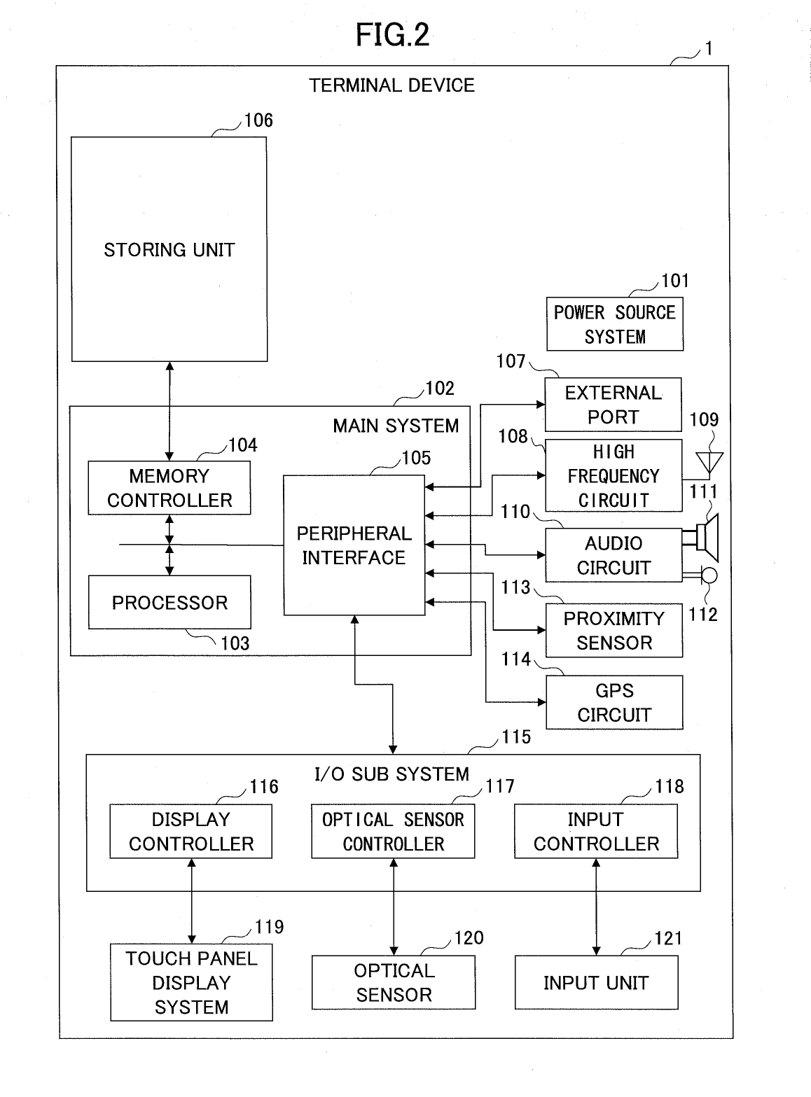

FIG. 2 is a block diagram illustrating an example of a hardware structure of the terminal device 1.

The terminal device 1 includes a power source system 101, a main system 102, a storing unit 106, an external port 107, a high frequency circuit 108, an antenna 109, an audio circuit 110, a speaker 111, a microphone 112, a proximity sensor 113, a Global Positioning System (GPS) circuit 114, an I/O sub system 115, a touch panel display system 119, an optical sensor 120 and an input unit 121. The main system 102 includes a processor 103, a memory controller 104 and a peripheral interface 105. The I/O sub system 115 includes a display controller 116, an optical sensor controller 117, and an input controller 118.

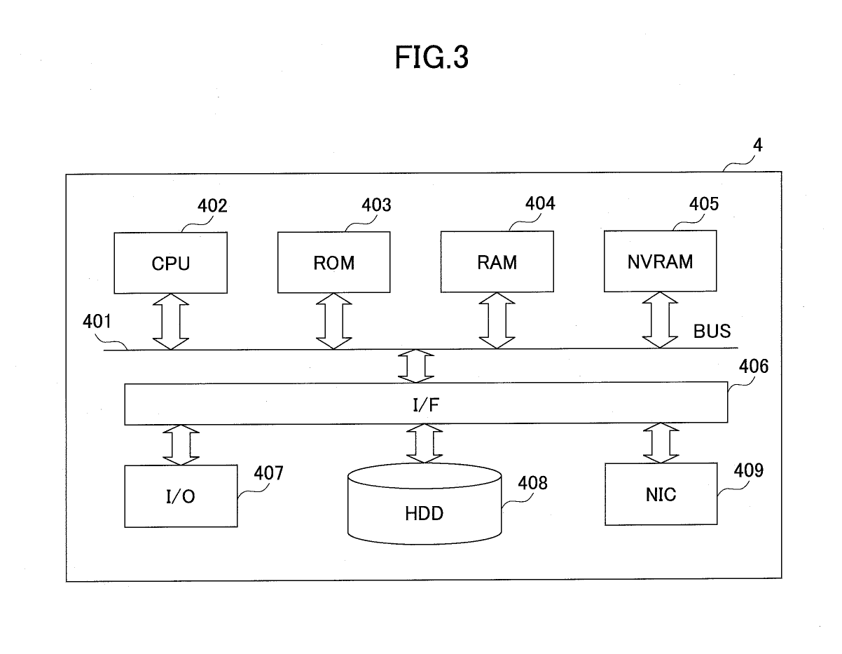

FIG. 3 is a block diagram illustrating an example of a hardware structure of the game processing server apparatus 4.

The game processing server apparatus 4 includes a Central Processing Unit (CPU) 402, a Read Only Memory (ROM) 403, a Random Access Memory (RAM) 404, a non-Volatile Random Access Memory (NVRAM) 405 and an Interface (I/F) 406 connected to a system bus 401, and an Input/Output Device (I/O) 407 such as a keyboard, a mouse, a monitor, a Compact Disk/Digital Versatile Disk (CD/DVD) drive or the like, a Hard Disk Drive (HDD) 408, and a Network Interface Card (NIC) 409 connected to the I/F 406, and the like.

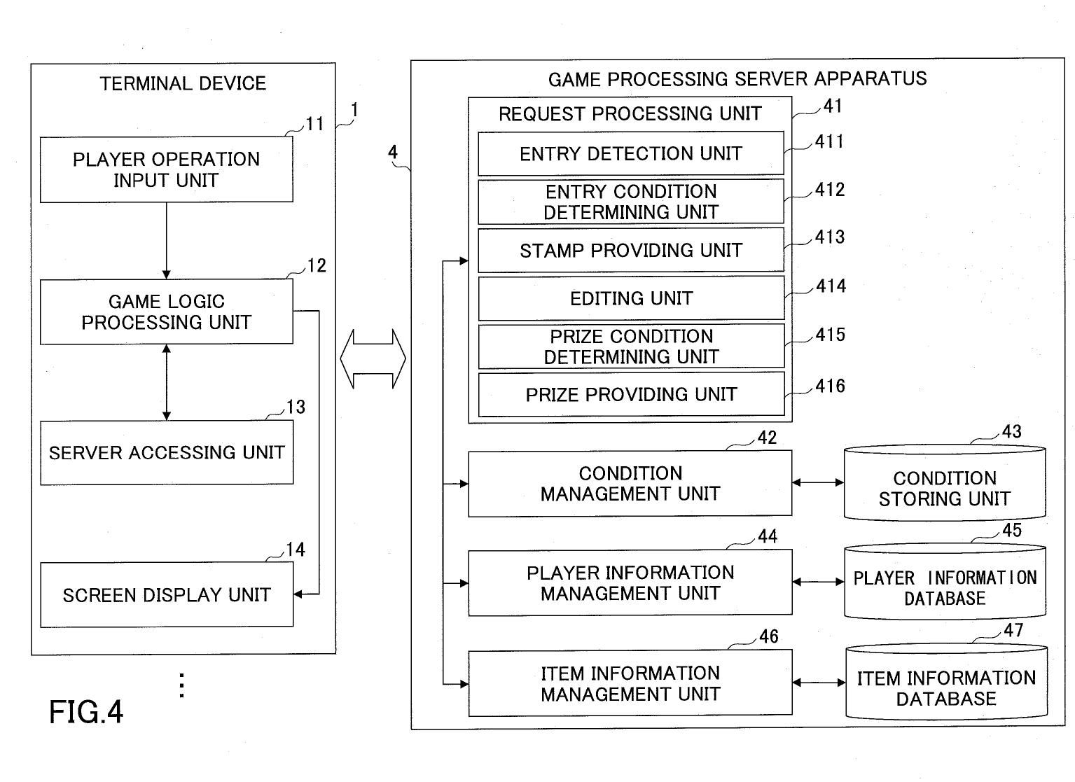

FIG. 4 is a block diagram illustrating an example of a functional structure of the terminal device 1 and the game processing server apparatus 4.

In FIG. 4, the terminal device 1 includes a player operation input unit 11, a game logic processing unit 12, a server accessing unit 13 and a screen display unit 14.

The player operation input unit 11 has a function to input (accept) an operation of a player of the terminal device 1.

The game logic processing unit 12 has a function to process a game by transitioning screens in accordance with the input operation by the player via the player operation input unit 11. The game logic processing unit 12 may execute the game logic based on page data described in a Hyper Text Markup Language (HTML) or the like and scripts or the like included in the page data sent from the game processing server apparatus 4 (which is called browser type). Alternatively, the game logic processing unit 12 may execute the game logic based on an application which is previously downloaded and installed in the terminal device 1 (which is called application type).

The server accessing unit 13 has a function to send a request to the game processing server apparatus 4 and receive a processed result or the like as a response from the game processing server apparatus 4 when it is necessary to access the game processing server apparatus 4 in a course of the processing by the game logic processing unit 12. Here, the request includes a request of updating and a request of referring to data. The request of updating is to update player information. The request of referring to data is to refer to the player information.

The screen display unit 14 has a function to display screens under control of the game logic processing unit 12.

The game processing server apparatus 4 includes a request processing unit 41, a condition management unit 42, a condition storing unit 43, a player information management unit 44, a player information database 45, an item information management unit 46, and an item information database 47.

The request processing unit 41 has a function to receive a request from the terminal device 1, perform a corresponding process and send a processed result of the request to the terminal device 1. When the request processing unit 41 receives the request of updating, the request processing unit 41 performs an operation to update the player information, and sends the updated player information or the like which is changed by the operation as the processed result. When the request processing unit 41 receives the request of referring to data, the request processing unit 41 refers to and obtains the corresponding player information, and sends the obtained player information as the processed result. The response may include screen information which is to be operated by the player next, in addition to the required processed result, for the browser type.

The request processing unit 41 also has a function to provide a stamp in accordance with an entry to a game and provide a prize in accordance with a status of collecting the stamps, in addition to the above described basic functions. The request processing unit 41 includes an entry detection unit 411, an entry condition determining unit 412, a stamp providing unit 413, an editing unit 414 (also an example of a notification unit), a prize condition determining unit 415 and a prize providing unit 416 for functional units to actualize the above function. Each of the functional units is explained later.

The condition management unit 42 has a function to manage a condition to provide a stamp (a predetermined entry condition) and a basic condition to provide a prize (a prize basic condition) stored in the condition storing unit 43. The condition management unit 42 refers to the predetermined entry condition or the prize basic condition in accordance with a request from the request processing unit 41.

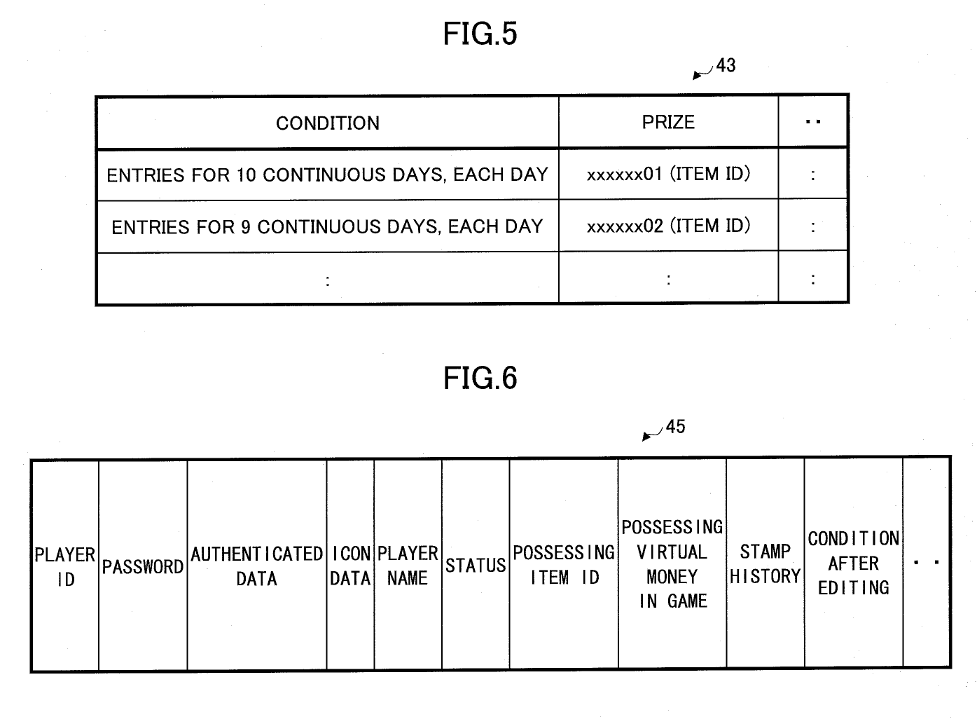

FIG. 5 is a view illustrating an example of a data structure of the condition storing unit 43. The condition includes a predetermined entry condition and a prize basic condition. Specifically, the condition includes fields such as “condition”, “prize” and the like. In FIG. 5, “entries for 10 continuous days, each day” as the condition and item ID “xxxxxx01” as the prize are exemplified.

Among the condition, “each day” corresponds to the predetermined entry condition by which a stamp is provided. It means that a stamp is provided for the first entry in each day. In other words, a stamp is not provided for the second or more entry in the same day. Here, other than each day, the predetermined entry condition may be each time span among time spans obtained by dividing a day (for example, in the morning (3:00 to 10:00), in the daytime (10:00 to 18:00), in the evening (18:00 to 3:00) or the like. In this case, a stamp is provided for the first entry in each time span.

Among the condition, “entries for 10 continuous days” corresponds to the prize basic condition. In this example, when the user collects stamps for 10 continuous days, a prize is given. The item ID “xxxxxx01” as the prize means that an item specified by the item ID is given to the user. When the item is given to the player, the player can posses the item in the game so that the player can use the item in a battle, give the item to another player as a gift, or the like.

In FIG. 5, the condition “entries for 9 continuous days, each day” is also exemplified. In this case, even when the player cannot enter the game for 10 continuous days, the player can get a prize “xxxxxx02” whose rank is lower than the prize “xxxxxx01” if the player enters the game for 9 continuous days. Alternatively, only a single prize may be prepared without preparing the prize whose rank is lower.

Further, the condition may not be limited to the day or the time span basis, and alternatively, a predetermined entry condition may be an entry from a predetermined place. For such a case, positional information obtained by a GPS function or the like of the terminal device 1 is used for the determination.

Referring back to FIG. 4, the player information management unit 44 has a function to manage various information about all of the players participating in the game, which are stored in the player information database 45. The player information management unit 44 refers to or updates the player information in accordance with the request from the request processing unit 41.

FIG. 6 is a view illustrating an example of a data structure of the player information stored in the player information database 45. The player information includes fields such as “player ID”, “password”, “authenticated data”, “icon data”, “player name”, “status”, “possessing item ID”, “possessing virtual money in game”, “stamp history”, “condition after editing”, and the like.

The “player ID” is data to specify (identify) the player. The “password” is data for authenticating the player when logging in or the like. The “authenticated data” is data such as session ID or the like indicating that the log-in is normally done. The “authenticated data” is also stored in the terminal device 1 as a cookie or the like. The “icon data” is data to specify a displayed icon of the player. The “player name” is data indicating a displayed name of the player. The “status” is data indicating a progression status of the game of the player. The “possessing item ID” is data specifying an item possessed by the player. The “possessing virtual money in game” is data indicating the remain or balance of the virtual money usable in the game possessed by the player.

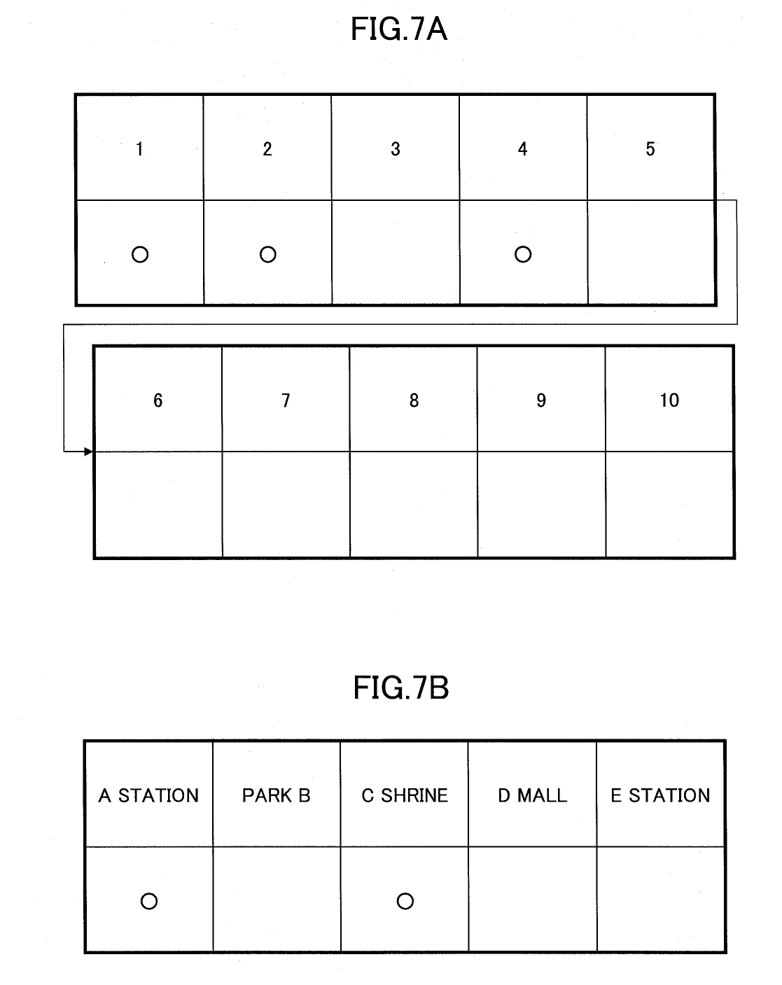

The “stamp history” is data indicating a status of collecting stamps of the player. FIG. 7A and FIG. 7B are views illustrating an example of the stamp history, respectively. FIG. 7A shows an example in which a stamp is given each day. FIG. 7B shows an example in which a stamp is given each place.

In FIG. 7A, storage areas indicating whether stamps are obtained each day for 10 days are provided. In this example, it is illustrated that the stamps are obtained for the first day, the second day and the fourth day, respectively.

In FIG. 7B, storage areas indicating whether stamps are obtained for areas including “A station”, “park B”, “C shrine”, “D mall” and “E station” are provided. In this example, it is illustrated that the stamps are obtained for the “A station” and the “C shrine”, respectively. As will be described later, the stamp history can be edited by the player by paying counter value (or compensation).

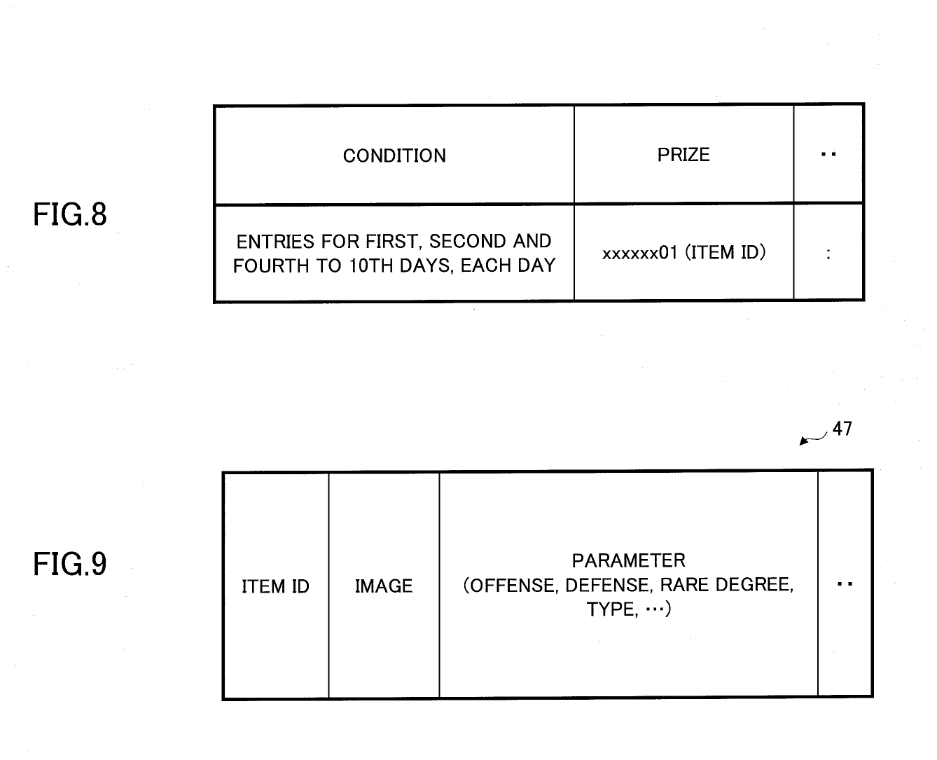

Referring back to FIG. 6, the “condition after editing” is data indicating the condition obtained by editing the predetermined entry condition or the prize basic condition stored in the condition storing unit 43 by the player by paying the counter value. The edited condition is effective only for the player. FIG. 8 is a view illustrating an example of the condition after editing. The original condition is as shown in FIG. 5. Here, the first condition shown in FIG. 5 the “entries for 10 continuous days, each day” is changed to “entries for first, second and fourth to 10th days, each day”. It means that the entry (the stamp) on the third day is unnecessary to obtain the prize.

Referring back to FIG. 4, the item information management unit 46 has a function to manage various information about items (game contents, game media), which are stored in the item information database 47. The items are such as cards, figures or the like possessed by players as digital contents. The item information management unit 46 refers to or updates the item information in accordance with the request from the request processing unit 41.

FIG. 9 is a view illustrating an example of a data structure of the item information stored in the item information database 47. The item information includes fields such as “item ID”, “image”, “parameter (offense, defense, rare degree, type, . . . )” and the like. The “item ID” is data to specify (identify) the item. The “image” is image data for displaying the item. The “parameter (offense, defense, rare degree, type, . . . )” is attributes of the item.

Referring back to FIG. 4, the entry detection unit 411 of the request processing unit 41 has a function to detect an entry to a game by the player who operates the terminal device 1. The entry detection unit 411 may detect the entry of the player when the player logs-in from the terminal device 1 to the game processing server apparatus 4 and is normally authenticated, or when the player accesses (requests) from the terminal device 1 to the game processing server apparatus 4 with authenticated data indicating that the player is already authenticated. Further, the entry detection unit 411 may detect the entry of the player when the player accesses a predetermined page (a top page of the game or my-page). In this case, the entry detection unit 411 may detect the entry of the player when the player accesses the predetermined page for the browser type, and may detect the entry of the player when the player initiates the application to open the predetermined page such as my-page and data indicating the player's action is sent to the game processing server apparatus 4 for the application type.

The entry condition determining unit 412 has a function to determine whether an entry is the specific entry for which a stamp is to be provided by referring to the predetermined entry condition stored in the condition storing unit 43 when the entry detection unit 411 detects the entry of the player. The predetermined entry condition may be, for example, each day (whether the entry is the first entry in the day), each time span (whether the entry is the first entry in the time span in the day), each place (whether the entry is the first time from a predetermined place), or the like.

The stamp providing unit 413 has a function to provide (register) a stamp (specific entry data) to the stamp history of the player information of the respective player in the player information database 45 when the entry condition determining unit 412 determines that the entry is the specific entry.

The editing unit 414 has a function to edit the stamp history of the player information database 45 or the condition of the condition storing unit 43 upon instruction by the player when a predetermined condition is met such as virtual money in the game is paid or the like. The edited condition is stored in the condition after editing of the player information of the respective player in the player information database 45. The player can obtain the virtual money in the game in accordance with the progression of the game or by paying real money. In addition to the virtual money in the game, the editing unit 414 may accept the edition by the player when the player pays something valuable (card, item or the like) in the game as the counter value.

The editing unit 414 may be configured to accept both of the edition to the stamp history and the predetermined entry condition/prize basic condition. At this time, the editing unit 414 may accept the edition to either of the stamp history and the predetermined entry condition/prize basic condition selected by the player or both of them at the same time. Alternatively, the editing unit 414 may be configured to edit either one of the stamp history and the predetermined entry condition/prize basic condition.

The prize condition determining unit 415 has a function to determine whether the status of the stamp history in the player information database 45 satisfies the condition. Specifically, when the condition after editing of the respective player exists in the player information database 45, the prize condition determining unit 415 determines whether the status of the stamp history in the player information database 45 satisfies the condition after editing. When the condition after editing of the respective player does not exist in the player information database 45, the prize condition determining unit 415 determines whether the status of the stamp history in the player information database 45 satisfies the prize basic condition stored in the condition storing unit 43.

The prize providing unit 416 has a function to provide a prize to the respective player when the prize condition determining unit 415 determines that the status satisfies the condition after editing or the prize basic condition. When the prize is an item, the item ID of the item as the prize is added to the possessing item ID of the player information in the player information database 45 for the respective player. When the prize is virtual money in the game, the virtual money in the game as the prize is added to the possessing virtual money in the game of the player information in the player information database 45 for the respective player.

### (Operation: Browser Type)

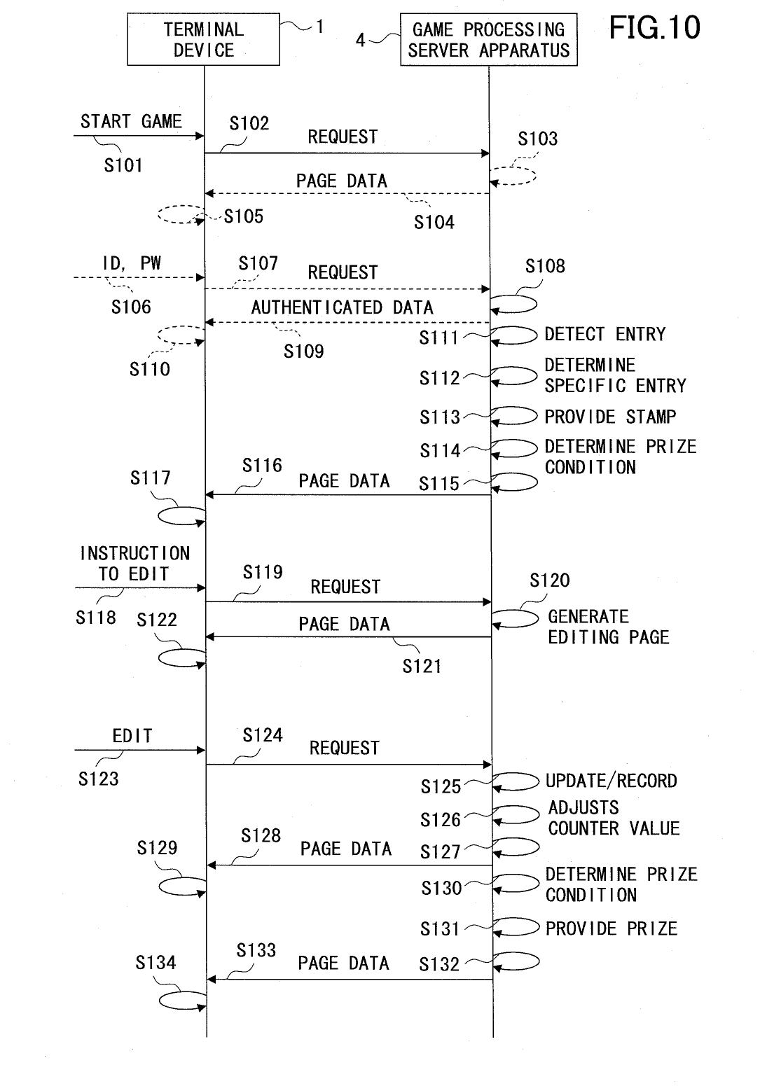

FIG. 10 is an example of a sequence diagram illustrating an example of an operation of the game processing server apparatus 4 and the terminal device 1 for the browser type.

In FIG. 10, when the player of the terminal device 1 instructs to start a game, and the player operation input unit 11 accepts the instruction (step S101), under control of the game logic processing unit 12, the server accessing unit 13 sends a request of a page to the game processing server apparatus 4 with the player ID and the authenticated data if they are already obtained (step S102).

At the game processing server apparatus 4, upon receiving the request, the request processing unit 41 generates a log-in page (step S103) when the request does not include the player ID and the authenticated data, and sends the page data to the terminal device 1 (step S104). The game logic processing unit 12 of the terminal device 1 displays the log-in page by the screen display unit 14 (step S105).

When the player of the terminal device 1 inputs the player ID (ID) and the password (PW) in the log-in page, and the player operation input unit 11 accepts the input (step S106), under control of the game logic processing unit 12, the server accessing unit 13 sends a request to the game processing server apparatus 4 with the player ID and the password (step S107). Here, when a membership registration of the player, authentication of the terminal device 1 or the like is performed, a corresponding operation is performed. However, explanation of such an operation is omitted.

At the game processing server apparatus 4, upon receiving the request with the player ID and the authenticated data or the request with the player ID and the password for logging-in, the request processing unit 41 performs a player authentication using the authenticated data or the player ID and the password (step S108).

When the player authentication using the player ID and the password is normally completed, the request processing unit 41 sends authenticated data to the terminal device 1 (step S109), and the game logic processing unit 12 of the terminal device 1 stores the received authenticated data in the terminal device 1 (step S110).

At the game processing server apparatus 4, the entry detection unit 411 of the request processing unit 41 detects the entry of the player to the game when the player authentication is normally completed (step S111). Alternatively, when it is set that the entry is detected when the player accesses a predetermined page (top page of the game or my-page), the entry detection unit 411 detects the entry of the player when the player accesses the predetermined page.

The entry condition determining unit 412 of the request processing unit 41 determines whether the entry is the specific entry by which a stamp is provided by referring to the predetermined entry condition stored in the condition storing unit 43, when the entry detection unit 411 detects the entry of the player (step S112). For example, when the predetermined entry condition is set for each day, the entry condition determining unit 412 determines whether the entry is the first one in the day. When the predetermined entry condition is set for each time span, the entry condition determining unit 412 determines whether the entry is the first one in the time span in the day. When the predetermined entry condition is set for each place, the entry condition determining unit 412 determines whether the entry is the first one from the predetermined place.

The stamp providing unit 413 of the request processing unit 41 provides (records) a stamp (specific entry data) to the stamp history of the player information of the respective player in the player information database 45 when the entry condition determining unit 412 determines that the entry is the specific entry (step S113).

Then, the prize condition determining unit 415 of the request processing unit 41 determines whether the status of the stamp history of the player information database 45 matches the condition (step S114). Specifically, when the condition after editing of the respective player exists in the player information database 45, the prize condition determining unit 415 determines whether the status of the stamp history of the player information database 45 matches the condition after editing. When the condition after editing of the respective player does not exist in the player information database 45, the prize condition determining unit 415 determines whether the status of the stamp history of the player information database 45 matches the prize basic condition in the condition storing unit 43.

Here, it is assumed that the status does not match the prize basic condition nor the condition after editing.

The editing unit 414 of the request processing unit 41 generates an edition introduction page for introducing to the player a notice indicating that the stamp history or the prize condition can be edited (step S115) and sends the page data to the terminal device 1 (step S116). The game logic processing unit 12 of the terminal device 1 displays the edition introduction page by the screen display unit 14 (step S117).

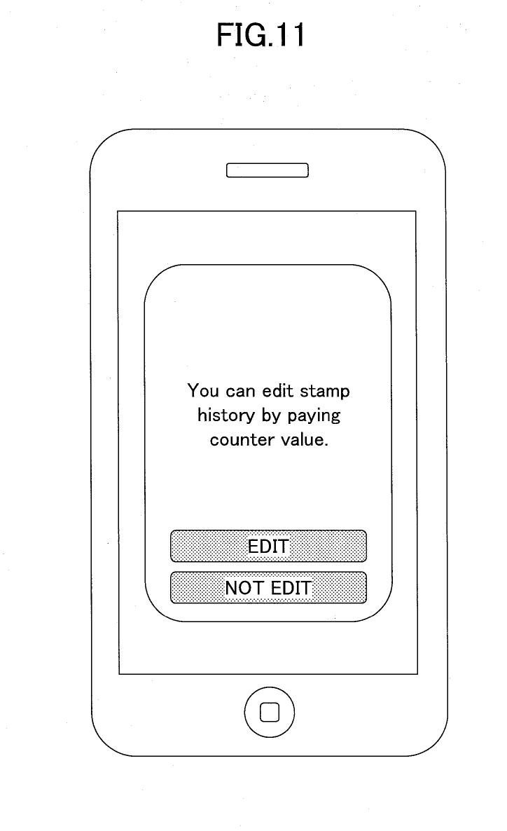

FIG. 11 is a view illustrating an example of the edition introduction page. In this page, a message “You can edit stamp history by paying counter value.” and buttons indicating “edit” and “not edit” are displayed.

Referring back to FIG. 10, when the player of the terminal device 1 taps the “edit” button (see FIG. 11) in the edition introduction page, and the player operation input unit 11 accepts the operation (step S118), under control of the game logic processing unit 12, the server accessing unit 13 sends a request of editing to the game processing server apparatus 4 (step S119).

At the game processing server apparatus 4, upon receiving the request, the editing unit 414 of the request processing unit 41 generates an editing page for accepting the edition (step S120) and sends the page data to the terminal device 1 (step S121). The game logic processing unit 12 of the terminal device 1 displays the editing page by the screen display unit 14 (step S122).

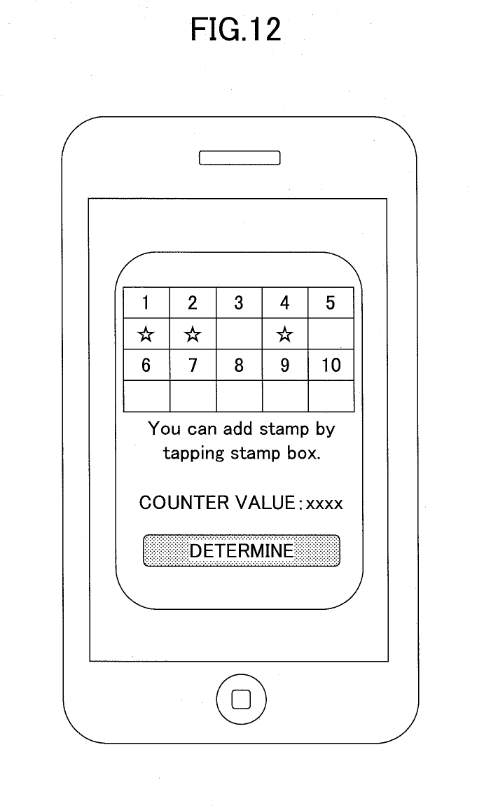

FIG. 12 is a view illustrating an example of the editing page in which the stamp history can be edited. In FIG. 12, a stamp table including 10 stamp boxes for 10 days, respectively, a message “You can add stamp by tapping stamp box.” or the like, counter value for added stamp, and a button indicating “determine” are displayed.

Referring back to FIG. 10, when the player of the terminal device 1 edits the editing page and taps the “determine” button and the player operation input unit 11 accepts the operation (step S123), under control of the game logic processing unit 12, the server accessing unit 13 sends a request to the game processing server apparatus 4 with the edited content (step S124).

At the game processing server apparatus 4, upon receiving the request, the editing unit 414 of the request processing unit 41 updates or records the stamp history or the condition after editing of the player information database 45 in accordance with the edited content (step S125).

The editing unit 414 of the request processing unit 41 adjusts the counter value for the edition (step S126). For example, when the counter value is paid by the virtual money in the game, the editing unit 414 subtracts the virtual money corresponding to the counter value from the possessing virtual money in the game of the respective player in the player information database 45. When the counter value is paid by the item, the editing unit 414 subtracts the item ID corresponding to the counter value from the possessing item ID of the respective player in the player information database 45.

Then, the editing unit 414 of the request processing unit 41 generates an edition completion page (step S127) and sends the page data to the terminal device 1 (step S128). The game logic processing unit 12 of the terminal device 1 displays the edition completion page by the screen display unit 14 (step S129).

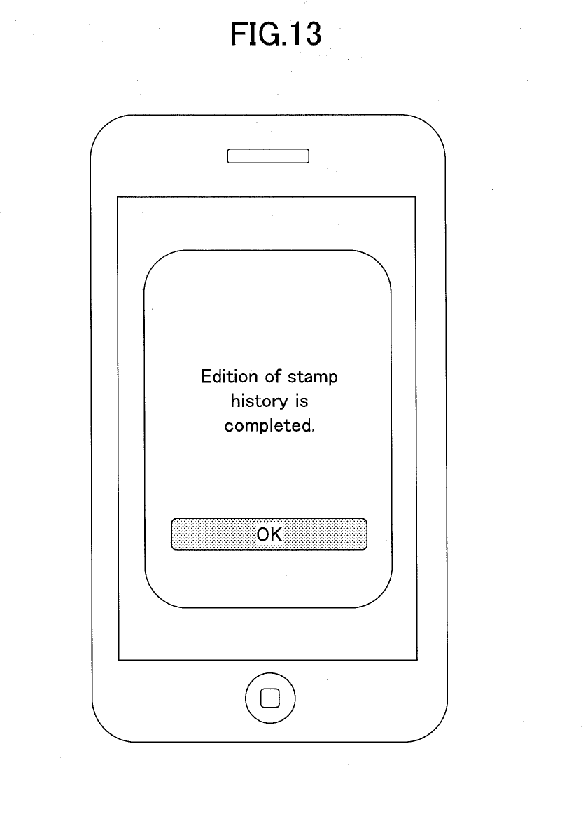

FIG. 13 is a view illustrating an example of the edition completion page. In FIG. 13, a message “Edition of stamp history is completed.” or the like and a button indicating “OK” are displayed.

Referring back to FIG. 10, at the game processing server apparatus 4, the prize condition determining unit 415 of the request processing unit 41 determines whether the status of the stamp history of the player information database 45 matches the condition (step S130). Specifically, when the condition after editing of the respective player exists in the player information database 45, the prize condition determining unit 415 determines whether the status of the stamp history of the player information database 45 matches the condition after editing. When the condition after editing of the respective player does not exist in the player information database 45, the prize condition determining unit 415 determines whether the status of the stamp history of the player information database 45 matches the prize basic condition in the condition storing unit 43.

It is assumed that the status matches either of the prize basic condition or the condition after editing. At this time, the prize providing unit 416 of the request processing unit 41 provides the prize to the respective player (step S131). For example, when the prize is an item, the prize providing unit 416 adds item ID of the prize to the possessing item ID of the player information of the respective player in the player information database 45. When the prize is virtual money in the game, the prize providing unit 416 adds virtual money in the game corresponding to the prize in the possessing virtual money in the game of the player information.

The prize providing unit 416 of the request processing unit 41 generates a prize present completion page (step S132) and sends the page data to the terminal device 1 (step S133). The game logic processing unit 12 of the terminal device 1 displays the prize present completion page by the screen display unit 14 (step S134).

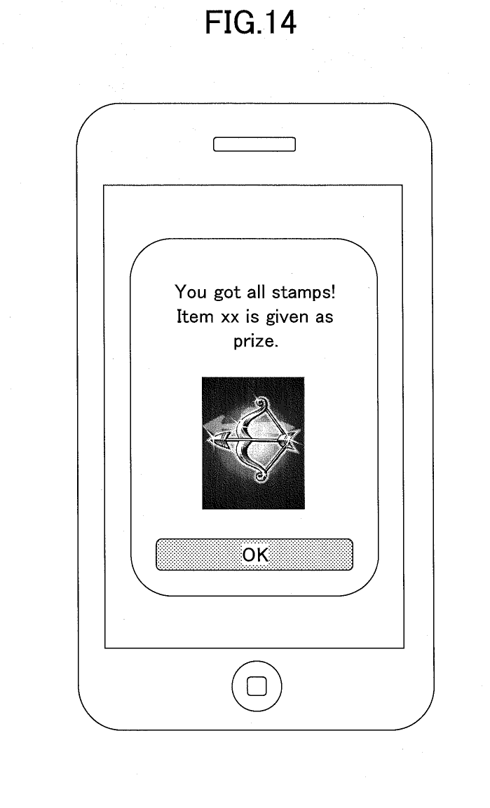

FIG. 14 is a view illustrating an example of the prize present completion page. In FIG. 14, a message “You got all stamps! Item xx is given as prize.” or the like, an image of the item, and a button indicating “OK” are displayed.

Here, in the above operation, an example that a notice indicating that the player can edit the stamp history or the predetermined entry condition/prize basic condition by paying the predetermined counter value is displayed in the edition introduction page when the player enters the game. Alternatively, even when the player does not enter the game, a mail, an instant message (IM) or the like indicating that the player can edit the stamp history or the predetermined entry condition/prize basic condition by paying the predetermined counter value may be sent from the game processing server apparatus 4 under a condition that it is found that the player does not enter the game for a predetermined period of days.

### (Operation: Application Type)

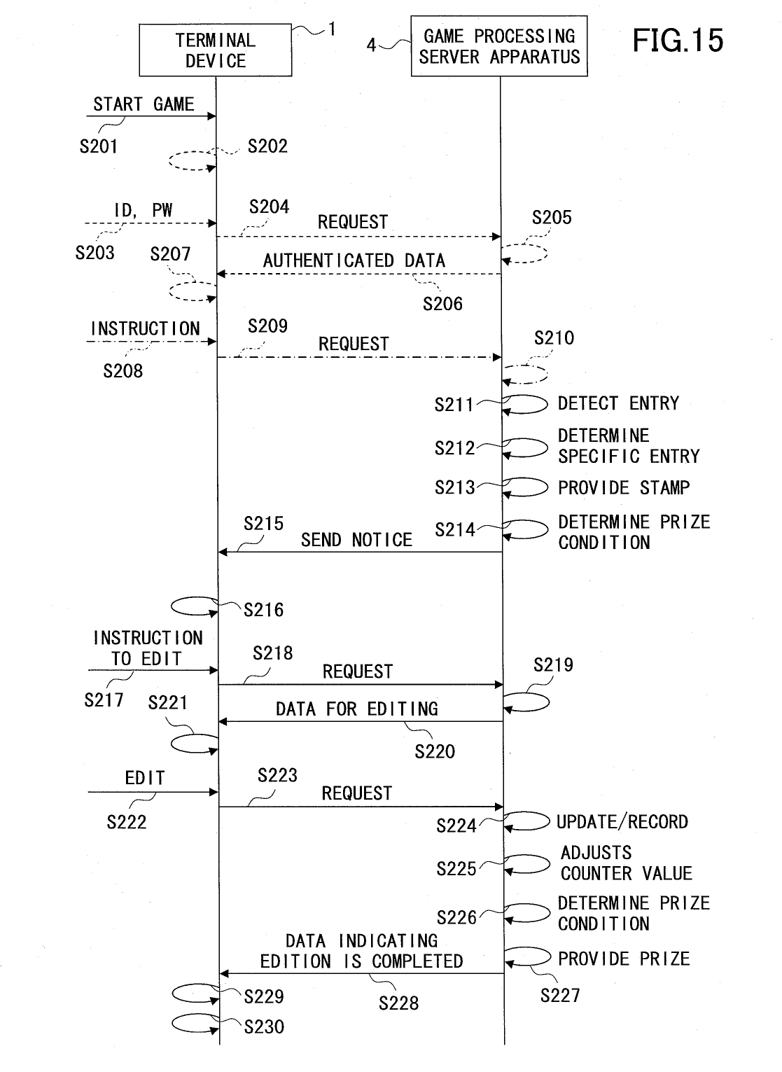

FIG. 15 is an example of a sequence diagram illustrating an example of an operation of the game processing server apparatus 4 and the terminal device 1 for the application type.

In FIG. 15, when the player of the terminal device 1 instructs to start a game, and the player operation input unit 11 accepts the instruction (step S201), the game logic processing unit 12 displays the log-in page by the screen display unit 14 when the player ID and the authenticated data are not obtained (stored) yet (step S202).

When the player of the terminal device 1 inputs the player ID and the password to the log-in page, and the player operation input unit 11 accepts the operation (step S203), under control of the game logic processing unit 12, the server accessing unit 13 sends a request to the game processing server apparatus 4 with the player ID and the password (step S204). Here, when a membership registration of the player, authentication of the terminal device 1 or the like is performed, a corresponding operation is performed. Here, explanation of such an operation is omitted.

At the game processing server apparatus 4, upon receiving the request with the player ID and the password for log-in, the request processing unit 41 performs a player authentication using the player ID and the password (step S205).

When the player authentication using the player ID and the password is normally performed, the request processing unit 41 sends authenticated data to the terminal device 1 (step S206). The game logic processing unit 12 of the terminal device 1 stores the received authenticated data in the terminal device 1 (step S207).

When the terminal device 1 already stores the player ID and the authenticated data, when the player of the terminal device 1 operates the terminal device 1 to access the server and the player operation input unit 11 accepts the operation (step S208), under control of the game logic processing unit 12, the server accessing unit 13 sends a request to the game processing server apparatus 4 with the player ID and the authenticated data (step S209).

At the game processing server apparatus 4, upon receiving the request with the player ID and the authenticated data, the request processing unit 41 performs the player authentication of the authenticated data (step S210).

When the player authentication using the player ID and the password or using the authenticated data is normally performed, the entry detection unit 411 of the request processing unit 41 detects the entry of the player to the game (step S211). Alternatively, when it is set that the entry is detected when the player accesses a predetermined page (top page of the game or my-page), the entry detection unit 411 detects the entry of the player when the player accesses the predetermined page.

The entry condition determining unit 412 of the request processing unit 41 determines whether the entry is the specific entry by which a stamp is provided by referring to the predetermined entry condition stored in the condition storing unit 43, when the entry detection unit 411 detects the entry of the player (step S212). For example, when the predetermined entry condition is set for each day, the entry condition determining unit 412 determines whether the entry is the first one in the day. When the predetermined entry condition is set for each time span, the entry condition determining unit 412 determines whether the entry is the first one in the time span in the day. When the predetermined entry condition is set for each place, the entry condition determining unit 412 determines whether the entry is the first one from the predetermined place.

The stamp providing unit 413 of the request processing unit 41 provides (records) a stamp (specific entry data) to the stamp history of the player information of the respective player in the player information database 45 when the entry condition determining unit 412 determines that the entry is the specific entry (step S213).

Then, the prize condition determining unit 415 of the request processing unit 41 determines whether the status of the stamp history of the player information database 45 matches the condition (step S214). Specifically, when the condition after editing of the respective player exists in the player information database 45, the prize condition determining unit 415 determines whether the status of the stamp history of the player information database 45 matches the condition after editing. When the condition after editing of the respective player does not exist in the player information database 45, the prize condition determining unit 415 determines whether the status of the stamp history of the player information database 45 matches the prize basic condition in the condition storing unit 43.

Here, it is assumed that the status does not match the prize basic condition nor the condition after editing.

The prize condition determining unit 415 of the request processing unit 41 sends a fact that the player's status does not reach the prize condition to the terminal device 1 (step S215).

Upon receiving the fact, the game logic processing unit 12 of the terminal device 1 displays an edition introduction page by the screen display unit 14 (step S216).

When the player of the terminal device 1 instructs to edit the edition introduction page, and the player operation input unit 11 accepts the operation (step S217), under control of the game logic processing unit 12, the server accessing unit 13 sends a request to obtain data for editing to the game processing server apparatus 4 (step S218).

At the game processing server apparatus 4, upon receiving the request, the editing unit 414 of the request processing unit 41 obtains data for editing necessary for edition such as the stamp history, the prize providing condition or the like (step S219) and sends the data for editing to the terminal device 1 (step S220).

Upon receiving the data, the game logic processing unit 12 of the terminal device generates an editing page based on the data for editing, and displays the page by the screen display unit 14 (step S221).

When the player of the terminal device 1 edits the editing page, and the player operation input unit 11 accepts the operation (step S222), under control of the game logic processing unit 12, the server accessing unit 13 sends a request to the game processing server apparatus 4 with the edited content (step S223).

At the game processing server apparatus 4, upon receiving the request, the editing unit 414 of the request processing unit 41 updates or records the stamp history or the condition after editing of the player information database 45 in accordance with the edited content (step S224).

Then, the editing unit 414 of the request processing unit 41 adjusts the counter value for the edition (step S225). For example, when the counter value is paid by the virtual money in the game, the editing unit 414 subtracts the virtual money corresponding to the counter value from the possessing virtual money in the game of the respective player in the player information database 45. When the counter value is paid by the item, the editing unit 414 subtracts the item ID corresponding to the counter value from the possessing item ID of the respective player in the player information database 45.

The prize condition determining unit 415 of the request processing unit 41 determines whether the status of the stamp history of the player information database 45 matches the condition (step S226). Specifically, when the condition after editing of the respective player exists in the player information database 45, the prize condition determining unit 415 determines whether the status of the stamp history of the player information database 45 matches the condition after editing. When the condition after editing of the respective player does not exist in the player information database 45, the prize condition determining unit 415 determines whether the status of the stamp history of the player information database 45 matches the prize basic condition in the condition storing unit 43.

It is assumed that the status matches either of the prize basic condition or the condition after editing. At this time, the prize providing unit 416 of the request processing unit 41 provides the prize to the respective player (step S227). For example, when the prize is an item, the prize providing unit 416 adds item ID of the prize to the possessing item ID of the player information of the respective player in the player information database 45. When the prize is virtual money in the game, the prize providing unit 416 adds virtual money in the game corresponding to the prize in the possessing virtual money in the game of the player information.

The editing unit 414 or the prize providing unit 416 of the request processing unit 41 sends data indicating that the edition is completed and a predetermined prize is provided to the terminal device 1 (step S228).

Upon receiving the data, the game logic processing unit 12 of the terminal device 1 displays an edition completion page and a prize present completion page by the screen display unit 14 (step S229, S230).

Here, in the above operation, an example that a notice indicating that the player can edit the stamp history or the predetermined entry condition/prize basic condition by paying the predetermined counter value is displayed in the edition introduction page when the player enters the game. Alternatively, even when the player does not enter the game, a mail, an instant message (IM) or the like indicating that the player can edit the stamp history or the predetermined entry condition/prize basic condition by paying the predetermined counter value may be sent from the game processing server apparatus 4 under a condition that it is found that the player does not enter the game for a predetermined period of days.

### Example for Edition and Providing Prize

A specific example for the edition and providing the prize is explained in the following.

### An Example to Obtain a Stamp for a Past Day on Which the Player could not Get the Stamp

This example is adaptable for a case that a stamp for a past day (time spam) cannot be obtained when a predetermined period has passed. For example, as illustrated in FIG. 7A, it is assumed that the player could not enter the game on the third day in a stamp rally by which a prize is given to a player when the player enters the game for 10 continuous days. If it is the fourth day today, the player basically cannot get the stamp for the third day anymore. Thus, even if the player enters the game for all of the rest of days, the fourth day to the tenth day, the player cannot get the prize, or the player can only get a prize that is inferior to the prize obtained for the case when the player continuously enters the game for all of the set days.

However, in this embodiment, the player can obtain a right to edit the stamp history by paying the virtual money or the like in the game. With this right, the player is able to edit the status of obtaining the stamp for the past day. Therefore, the player is able to edit the stamp history such that the player obtains the stamp for the third day.

Then, after the player edits the stamp history as described above, and the player enters the game for all of the rest of days, the fourth day to the tenth day, the stamps are collected for all of the boxes of the stamp rally and the player can get the prize.

Instead of the edition to the stamp history, or in addition to the edition to the stamp history, the player may obtain a right to edit the predetermined prize condition by paying virtual money or the like in the game. At this time, the player gets a right to edit, by paying the virtual money in the game or the like, the predetermined prize condition to, for example, “entries for first, second and fourth to 10th days, each day”. With this, the player can get the prize even when the player did not enter the game on the third day.

Further, this example is also adaptable for a case that a prize can be provided when the player enters the game for more than or equal to predetermined days within a predetermined period. For such a case, if the player starts the game at rather end of the period, it may be impossible for the player to obtain the prize. For example, under a condition that the player can get a prize when the player enters the game more than or equal to 10 days within a certain two weeks, if the player starts the game on the sixth day in the two weeks, there is only 9 days left so that it is impossible for the player to get the prize. For example, at this case, the player is capable of obtaining a stamp for one of 1st to 5th days so that the player can get the prize.

### An Example to Obtain a Stamp to Continue Continuous Entries

This example is adaptable for a case that a prize can be provided when the player continuously enters the game for predetermined days (for example, 10 continuous days or the like). In this case, it is assumed that if the player does not enter the game for a day, the record is deleted so that the player needs to start from the first day. Thus, if the player cannot enter the game on the third day, when the player enters the game on the fourth day, a message such as “You didn't enter the game on the third day. Do you want to edit entry data?” or the like is displayed. Then a screen to accept a payment of the counter value from the player is displayed. When the player selects to edit the entry data by paying the counter value, the player is able to edit the stamp history such that the player enters the game on the third day. Then, the status for the player becomes that the player enters the game for four continuous days.

### An Example to Obtain a Stamp for a Future Day (or Time Span) in Advance

For this case, the player can edit the stamp history such that the stamps for future days are obtained. At this time, the system may be configured to provide a plurality of stamps at once by editing. For example, the player may obtain all of the stamps for second to 14th days on first day so that the player can get the prize earlier than other players. Thus, for example, by using the prize, a rare item or the like, the player can dominantly battle against other players. Therefore, the player can make a strategy in the game.

### An Example to Obtain a Stamp for a Place where the Player has not Visited

This example is adaptable for a case of a stamp rally in which the player can get a stamp by entering the game at a specific place in a real world by using GPS function or the like of the terminal device 1.

The places at which the player can obtain stamps, respectively, are previously determined. The player can obtain a stamp by going to the place and entering the game at the place. For example, for the example of the stamp history shown in FIG. 7B, the status in which the player visited A station and C shrine and enters the game at those places to obtain the samples, respectively, is shown. When the player fills all of the stamp boxes (when the player obtains stamps at park B, D mall and E station as well for the case shown in FIG. 7B), the player can obtain a prize. The prize condition determining unit 415 determines whether the entry by the player satisfies the condition to give a stamp to the player. For example, the prize condition determining unit 415 determines that the stamp is given to the player when the player enters the game within the predetermined area and the player has not received a stamp for the area, or the like. In this example, the player can obtain a stamp for the place where the player has not actually visited (park B, D mall or E station for the case shown in FIG. 7B) by paying predetermined counter value (virtual money in the game or the like).

According to the embodiment, a user is given an option to obtain a stamp or the like that the user had missed by paying predetermined counter value so that it is possible to encourage the user to continue the game even when the user had once missed the stamp or the like.

The embodiment is applicable for an example in which the stamp rally is not performed.

For example, the embodiment is applicable for an example in which a prize is given based on the number of stamps collected by the player by simply counting the number of stamps.

The individual constituents of the game processing server apparatus 4 and the terminal device 1 may be embodied by arbitrary combinations of hardware and software, typified by a CPU of an arbitrary computer, a memory, a program loaded in the memory so as to embody the constituents illustrated in the drawings, a storage unit for storing the program such as a hard disk, and an interface for network connection. It may be understood by those skilled in the art that methods and devices for the embodiment allow various modifications.

Although a preferred embodiment of the game processing server apparatus 4 and the terminal device 1 has been specifically illustrated and described, it is to be understood that minor modifications may be made therein without departing from the spirit and scope of the invention as defined by the claims.

The present invention is not limited to the specifically disclosed embodiments, and numerous variations and modifications and modifications may be made without departing from the spirit and scope of the present invention.

The present application is based on and claims the benefit of priority of Japanese Priority Application No. 2012-169734 filed on Jul. 31, 2012, the entire contents of which are hereby incorporated by reference.

What is claimed is:

1. A server apparatus comprising:
an entry detection unit that detects an entry by a user from a terminal device;
an entry condition determining unit that determines whether the entry satisfies a predetermined entry condition when the entry is detected by the entry detection unit;
an entry history storing unit that stores at least a history of the entry that satisfies the predetermined entry condition;
a predetermined entry data providing unit that stores data indicating that the entry satisfies the predetermined entry condition as the history in the entry history storing unit when the entry condition determining unit determines that the entry satisfies the predetermined entry condition;
an editing unit that accepts an edition to the history under a condition that a predetermined counter value by the user is accepted;
a prize condition determining unit that determines, in a current condition, whether the history satisfies the prize condition; and
a prize providing unit that provides a prize to the user when, in the current condition, the history satisfies the prize condition.

2. A server apparatus comprising:
an entry detection unit that detects an entry by a user from a terminal device;
an entry condition determining unit that determines whether the entry satisfies a predetermined entry condition when the entry is detected by the entry detection unit;
an entry history storing unit that stores at least a history of the entry that satisfies the predetermined entry condition;
a predetermined entry data providing unit that stores data indicating that the entry satisfies the predetermined entry condition as the history in the entry history storing unit when the entry condition determining unit determines that the entry satisfies the predetermined entry condition;
an editing unit that accepts an edition to a prize condition under a condition that a predetermined counter value by the user is accepted;
a prize condition determining unit that determines, in a current condition, whether the history satisfies the prize condition; and
a prize providing unit that provides a prize to the user when, in the current condition, the history satisfies the prize condition.

3. The server apparatus according to claim 1, further comprising:
a notification unit that notifies a fact that the user is capable of editing the history by paying the predetermined counter value to the user when the prize condition determining unit determines, in the current condition, that the history does not satisfy the prize condition.

4. The server apparatus according to claim 2, further comprising:
a notification unit that notifies a fact that the user is capable of editing the prize condition by paying the predetermined counter value to the user when the prize condition determining unit determines, in the current condition, that the history does not satisfy the prize condition.

5. A non-transitory computer-readable recording medium having recorded thereon a program for a server apparatus that causes a computer to execute functions comprising:
an entry detection function that detects an entry by a user from a terminal device;
an entry condition determining function that determines whether the entry satisfies a predetermined entry condition when the entry is detected by the entry detection function;
an entry history storing function that stores at least a history of the entry that satisfies the predetermined entry condition;
a predetermined entry data providing function that stores data indicating that the entry satisfies the predetermined entry condition as the history in the entry history storing function when the entry condition determining function determines that the entry satisfies the predetermined entry condition;
an editing function that accepts an edition to the history or a prize condition under a condition that a predetermined counter value by the user is accepted;
a prize condition determining function that determines, in a current condition, whether the history satisfies the prize condition; and
a prize providing function that provides a prize to the user when, in the current condition, the history satisfies the prize condition.
